(19) United States
(12) Patent Application Publication
(10) Pub. No.: US 2003/0186691 A1
(43) Pub. Date: Oct. 2, 2003

(54) Method for remotely controlling repeaters of a communications network

(76) Inventor: Rack-June Baek, Seoul (KR)

Correspondence Address: MARK M. TAKAHASHI, GRAY CARY WARE & FREIDENRICH, LLP, 4365 EXECUTIVE DRIVE, SUITE 1100, SAN DIEGO, CA, 92121-2133, US

(21) Appl. No.: 10/157,435

(22) Filed: May 29, 2002

(30) Foreign Application Priority Data
Mar. 27, 2002 (CA) 2,380,694

(51) Int. Cl. H04M 3/00

(52) U.S. Cl. 455/420; 455/406; 455/423

(57) ABSTRACT

A method of remotely controlling a repeater of a communications network by assigning a unique identification number to each repeater and allowing the transmission of a wireless signal indicating status information and error information of the repeater from the repeater to a remote server, so that the operation status or an operation error is remotely checked and electricity fare is charged to the communications carrier appropriately. The remote control method of the present invention is implemented in a repeater having an identification number and a chipset for transceiving a wireless signal. The method comprises the steps of: (a) storing a unique identification number of a repeater to be installed in a database of a remote server; (b) receiving a wireless signal from a terminal chipset of the repeater using a control terminal chipset installed at a remote site; (c) determining whether the wireless signal is an error signal or a status indication signal; (d) storing the wireless signal discriminated in said step (c) in a database of the remote server; (e) providing location information of the repeater and error information to an A/S service center server to ask a troubleshooting of the repeater in the case that the wireless signal is determined to be the error signal in said step (c); and (i) storing the troubleshooting result in the database of the remote server through Internet.

### RELATED APPLICATION

This application claims priority of Canadian patent application serial number 2,380,694, filed Mar. 27, 2002.

### BACKGROUND OF THE INVENTION

1. Field of the Invention

The present invention relates to a method for controlling repeater of a wireless communications system and, more particularly, to a method for remotely maintaining and controlling a repeater by checking the operation status of the repeater by a wireless signal indicating the operation status.

2. Description of Related Arts

A conventional repeater in a communications network does not have a function of automatically notifying the operator of the repeater whether the repeater is operating properly or not. Thus, checking of the operation status of the repeater was dependent partly on the owner of the site in which the repeater is installed or a third party. Such a notification system, however, may deteriorate the quality of service and give the service users inconveniences because it is possible that nobody informs an error of the repeater or the notification is delayed for a long time.

The present inventors note another problem in an in-building repeater which is installed in a basement of a building or an apartment house. Occasionally, however, the electricity fare for the in-building repeater is paid by the owner of the building or residents of the apartment house because the electricity fare is typically charged in a unit of a building and all residents share common costs in case of the apartment house. In such a case, a consumer who pays the communications service fee additionally pays the electricity fare for operating the system or the repeater which a communications carrier is responsible for. Even though it is reasonable that the electricity fare for the repeater is charged to a corresponding communications carrier and the operation of the repeater is stopped when the carrier does not pay the fare, it difficult to charge the electricity fare to the carrier because a conventional repeater (particularly, an in-building repeater) is not provided with a means for administering the operation after its installment.

### SUMMARY OF THE INVENTION

To address the above problems, the present invention provides a method of remotely controlling a repeater of a communications network by assigning a unique identification number to each repeater and allowing the transmission of a wireless signal indicating status information and error information of the repeater from the repeater to a remote server, so that the operation status or an operation error is remotely checked and electricity fare is charged to the communications carrier appropriately.

The remote control method of the present invention is implemented in a repeater having an identification number and a chipset for transceiving a wireless signal. The method comprises: storing a unique identification number of a repeater to be installed in a database of a remote server; receiving a wireless signal from a terminal chipset of the repeater using a control terminal chipset installed at a remote site; determining whether the wireless signal is an error signal or a status indication signal; storing the discriminated wireless signal in a database of the remote server; providing location information of the repeater and error information to an A/S service center server to ask a troubleshooting of the repeater in the case that the wireless signal is determined to be the error signal; and storing the troubleshooting result in the database of the remote server through Internet.

According to the present invention, the operation status or an operation error can be remotely checked, which facilitates quick troubleshooting of any operation problem of the repeater. Also, the electricity fare for a repeater is charged to a communication carrier, which prevents that the fare is imposed on the service user duplicatively.

### BRIEF DESCRIPTION OF THE DRAWINGS

The above objectives and advantages of the present invention will become more apparent by describing in detail preferred embodiments thereof with reference to the attached drawings in which:

FIG. 1 illustrates the configuration of a remote repeater control system according to the present invention;

FIG. 2 illustrates the repeater shown in FIG. 1;

FIG. 3 is a flowchart showing the operation of the remote repeater control system according to the present invention; and

FIG. 4 is a flowchart showing an example of a method of administering electricity fare of a repeater according to the present invention.

### DETAILED DESCRIPTION OF PREFERRED EMBODIMENTS

Referring to FIG. 1, a preferred embodiment of a remote repeater control system according to the present invention includes a repeater 101, a repeater terminal chipset 102, a control terminal chipset 103, a remote server 104, and after-sale service (A/S) center server 105. The repeater 101 transmits a wireless signal to the control terminal chipset 103 through the repeater terminal chipset 102. The control terminal chipset 103 receives the wireless terminal and stores the information contained in the signal in a database of the remote server 104. The A/S center server 105 is connected to the remote server 104 through the Internet.

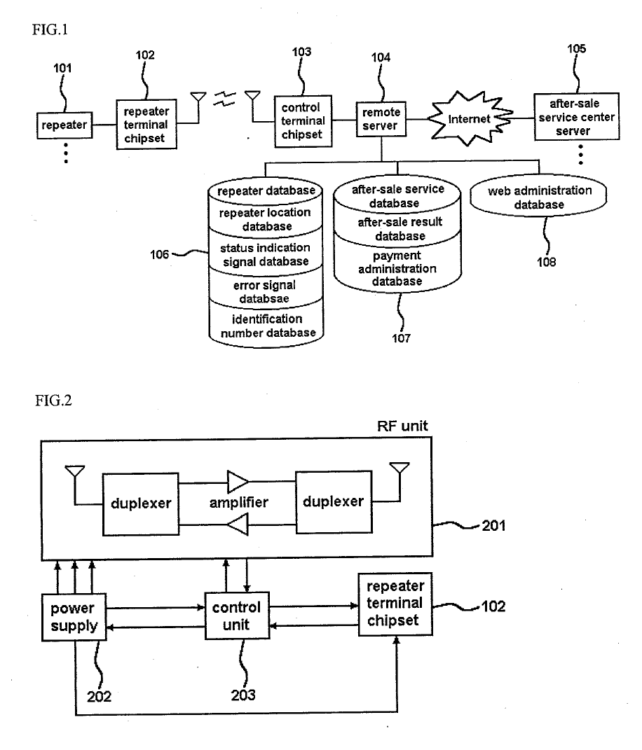

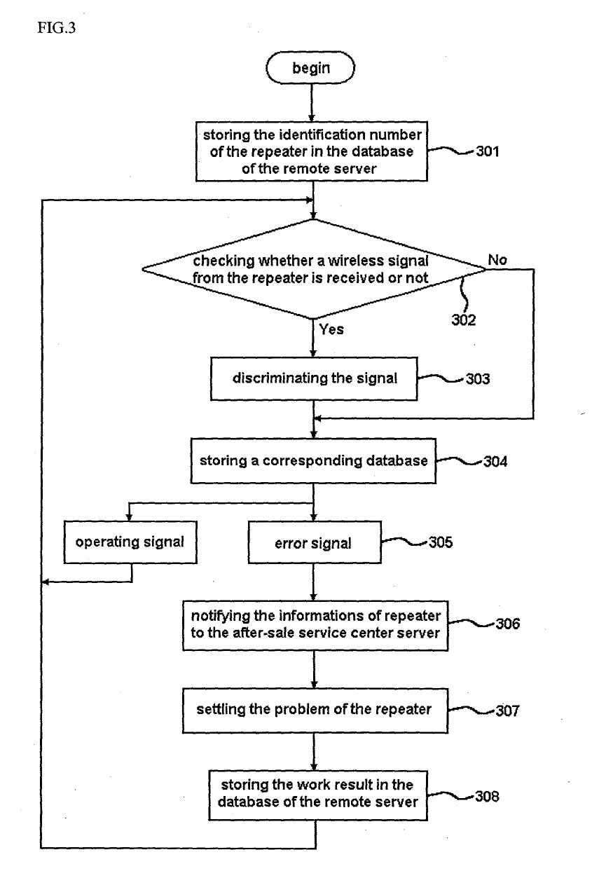

As shown in FIG. 2, the repeater 101 includes a radio frequency (RF) unit 201, a power supply 202, and a control unit 203. The RF unit 201 includes an antenna for transmitting and receiving a signal, a duplexer for separating received signals from transmitted signals and removing unnecessary frequencies, and an amplifier for amplifying the signal output by the duplexer. The power supply 202 supplies the repeater 101 with power. The controller 203, which may be implemented by use of a microprocessor, controls overall operation of the repeater 101 such as turning on or off of a power switch.

The repeater terminal chipset 102 and the control terminal chipset 103 are configured such that any transmit data is directed to a designated terminal. The repeater terminal chipset 102, which is connected to the controller 203 of the repeater 101 as shown in FIG. 2, receives an identification number of the repeater, an error signal, and a power signal from the controller 203 to transmit such signals to the control terminal chipset 103 located in a remote site. The control terminal chipset 103 of the remote site transmits a power control signal for controlling repeater power to each repeater terminal chipset 102.

The repeater 101, having a unique identification number, is assigned a database space in the remote server 104 before being installed in an arbitrary site, so that information carried by a wireless signal directed to a corresponding identification number is stored in the database. The control terminal chipset 103 receives a wireless signal from respective repeater chipset 102, and the information carried by the received signal is stored in a corresponding database space.

The remote server 104 classifies information of repeaters according to the identification numbers and stores such information in the database. When a repeater transmits a wireless signal containing its identification number, the remote server 104 verifies the repeater according to the identification number and determines whether the wireless signal is a status indication signal or an error signal. If the signal is the status indication signal, the remote server 104 stores the signal information in a operation signal database. If the signal is the error signal, however, the remote server 104 stores the signal information in a error signal database and provides location information of the repeater and error information, through the Internet, to an A/S service center server 105 to ask a troubleshooting of the repeater. The database of the remote server 104 includes a repeater database 106 for maintaining repeaters, an A/S service database 107 for after-sale services of repeaters, and a web administration database 108. The repeater database 106 includes an identification number database, a repeater location database, a status indication signal database, and a error signal database.

The A/S service center database 107 classifies after-sale service result data and cost or fare related data according to the A/S service centers and stores such data. Each A/S service center accesses the remote server of the present invention through the Internet to report the after-sale service results of repeaters and cost payment results.

In FIG. 1, the A/S service center server 105 is connected to the remote server of the present invention through the Internet, so that a service personnel is dispatched in response to a repeater A/S request from the remote server.

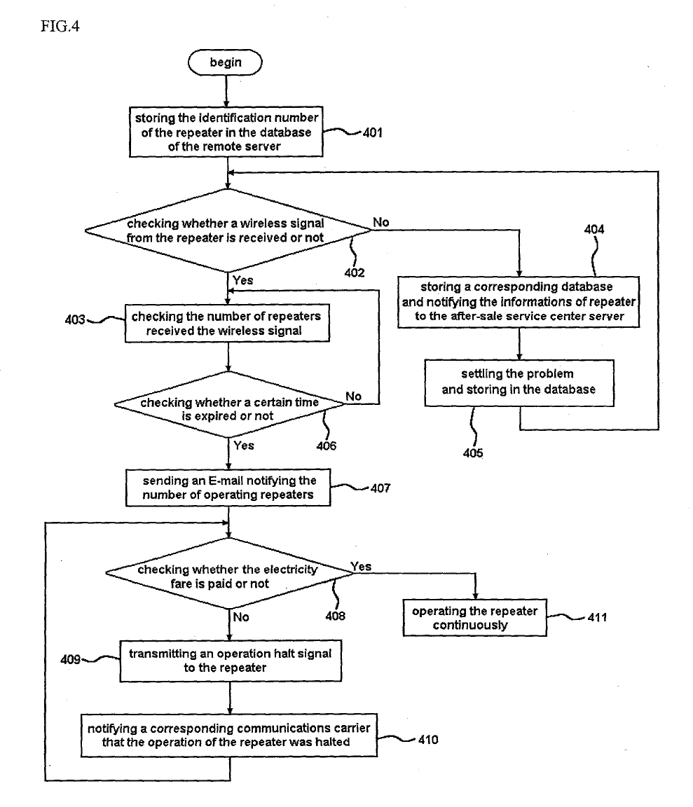

FIG. 3 shows the operation of an example of the remote repeater control system according to the present invention. Before a repeater 101 equipped with a terminal chipset 102 is installed in an arbitrary site, the identification number of the repeater 101 is stored in the database (step 301). In step 302, it is checked whether a wireless signal from the terminal chipset 102 of the repeater 101 is received or not. If the wireless signal is received in the step 302, the signal is discriminated and stored in a corresponding database (steps 303 and 304). If the wireless signal is not received in the step 302, however, it is regarded that an error signal has been received and the error signal is stored a corresponding database (step 304).

In the case that the signal stored in the database in the step 304 is the status indication signal, the process proceeds to the step 302 to wait for another signal from the repeater. If the signal stored in the database in the step 304 is an error signal, the location and the operation status of the repeater are notified to the A/S service center server 105 through the Internet to request an A/S action (steps 305 and 306). Upon receiving the A/S request, the A/S service center server 105 enables a service personnel to settle the problem of the repeater and transmits the work result to the remote server so that the remote server stores the result data (steps 307 and 308).

After the manipulation result is stored in the remote server 104, the process proceeds to the step 302 to wait for another signal from the repeater. Repetitive carrying out of the above procedure enables the operator to remotely manage the repeater. FIG. 4 is a flowchart showing an example of a method of administering electricity fare of a repeater according to the present invention. Before a repeater 101 equipped with a terminal chipset 102 is installed in an arbitrary site, the identification number of the repeater 101 is stored in the database of remote server 104 (step 401). In step 402, it is checked whether a wireless signal from the terminal chipset 102 of the repeater 101 is received or not. If the wireless signal is not received in the step 402, it is regarded that an error signal has been received and the error signal is stored a corresponding database.

Also, the location and the operation status of the repeater are notified to the A/S service center server 105 through the Internet to request an A/S action (step 404). Upon receiving the A/S request from the remote server 104, the A/S service center server 105 enables a service personnel to settle the problem of the repeater and transmits the work result to the remote server so that the remote server stores the result data (step 405). Then, the process proceeds to the step 402.

The remote server 104 checks, in step 403, the number of repeaters when the wireless signal is received in the step 402, and sends an E-mail notifying the number of operating repeaters to the remote server 104 after a certain time (steps 406 and 407). The interval, which can be chosen arbitrarily, may be one month, for example.

The remote server 104 checks whether the electricity fare had been paid for the corresponding repeater. If the electricity fare had been paid for the repeater, the remote server 104 continues to operate the repeater (step 411). If, however, the electricity fare had not been paid for the repeater, the remote server 104 transmits an operation halt signal to the repeater terminal chipset 102 through the control terminal chipset 103, so that the controller 203 of the repeater terminal chipset 102 cuts off the power of the repeater (step 409). After halting the operation of the repeater, the remote server 104 notifies a corresponding communications carrier that the operation of the repeater was halted because of the unpayment of the electricity fare (step 410). Afterwards, the process proceeds to the step 408 so that the payment of the fare is checked repetitively.

The electricity fare can be paid directly or by another. According to a direct payment method, the communications carrier pay the fare for itself, and then transmits an E-mail containing information of paid amount, date, and recipient of the payment to the remote server through the Internet, so that the operator of the remote server checks the payment. According to an indirect payment method, the operator of the remoter server receives the electricity fare from each carrier and indirectly pays the operation fees of the corresponding carrier. To be more specific, after the remote server sends a billing E-mail for charging the electricity fare to the carrier, the operator of the remote server receives and pays the fees and then sends a payment confirmation E-mail to the carrier.

Although the present invention has been described in detail above, it should be understood that the foregoing description is illustrative and not restrictive. Those of ordinary skill in the art will appreciate that many obvious modifications can be made to the invention without departing from its spirit or essential characteristics. Thus, it should be apparent that the invention can be modified in arrangement and detail without departing from such principles. We claim all modifications and variation coming within the spirit and scope of the following claims.

What is claimed is:

1. A method of remotely controlling a repeater having an identification number and a chipset for transceiving a wireless signal, said method comprising:
storing a unique identification number of a repeater to be installed in a database of a remote server;
receiving a wireless signal from a terminal chipset of the repeater using a control terminal chipset installed at a remote site;
determining whether the wireless signal is an error signal or a status indication signal;
storing the wireless signal discriminated in said determining step in a database of the remote server;
providing location information of the repeater and error information to an A/S service center server to ask a troubleshooting of the repeater in the case that the wireless signal is determined to be the error signal in said determining step; and
storing the troubleshooting result in the database of the remote server through Internet.

2. The method as claimed in claim 1, further comprising the steps of:
sending an E-mail to each of a plurality of communications carrier for notifying the number of operating repeaters;
checking whether the electricity fare had been paid for the repeater;
transmitting an operation halt signal to a repeater terminal chipset of the repeater, in the case that the electricity fare had not been paid for the repeater, to cut off power of the repeater;
notifying the communications carrier that the operation of the repeater was halted; and
transmitting an operation restart signal after the communications carrier settle a unpaid fare,
whereby administering operation fare of the repeater by using the wireless signal received from the repeater terminal chipset and checking the number of repeaters.

3. The method as claimed in claim 2, wherein the payment of the electricity fare is checked, in said checking step, by a E-mail which is sent by the communications carrier to the remote server after paying the fare and contains paid amount, date, and recipient of the payment.

4. The method as claimed in claim 2, wherein said checking step comprises the steps of:
sending a billing E-mail for charging the electricity fare to the carrier; and
sending a payment confirmation E-mail to the carrier after receiving and indirectly paying the fee.
